(19) United States
(12) Patent Application Publication
(10) Pub. No.: US 2009/0161147 A1
(43) Pub. Date: Jun. 25, 2009

(54) Personal document container

(75) Inventor: Daniel Leo Klave, Camas, WA (US)

Correspondence Address: THE NATH LAW GROUP, 112 SOUTH WEST STREET, ALEXANDRIA, VA, 22314, US

(73) Assignee: SHARP LABORATORIES OF AMERICA, INC., CAMAS, WA (US)

(21) Appl. No.: 12/003,130

(22) Filed: Dec. 20, 2007

(51) Int. Cl. G06F 15/00

(52) U.S. Cl. 358/1.15

(57) ABSTRACT

Systems, methods and devices for personal electronic document management are provided. The system includes a multifunction peripheral having an interface module connected thereto. The interface module includes a processor circuit with instructions for manipulating electronic files. The interface is configured to be capable of creating, modifying and accessing a personal document container. The personal document container is an XML Paper Specification (XPS) File.

### BACKGROUND OF THE INVENTION

1. Field of the Invention

The present subject matter relates generally to management of electronic documents and images, and more particularly to a personal document management system capable of being created, modified and accessed on a multi-function peripheral device (MFP), as well as methods and systems comprising the same.

2. Related Art

Electronic document and image management has become increasingly important as advances in technology are realized. Often, electronic documents and images are created and/or managed with an imaging device. Imaging devices may have several functions and capabilities tailored for specific uses or combinations of uses for both industrial and personal use. Examples of imaging devices include printers, facsimile devices, copiers, scanners, display monitors, multi-function peripherals, filing devices, web publishing devices, imagesetters, and platesetters, among others.

In the past, electronic documents and/or images may have been stored and/or managed by a document management system (DMS). A DMS is a type of computer system capable of storing and retrieving electronic documents and/or images. The documents and images stored on a DMS may be held in a wide variety of formats or in a number of geographic locations. A DMS may be configured to allow for the control and recording of changes to documents. Additionally, a DMS may be configured to measure the volume of use of documents stored and/or retrieved. Generally, a DMS is a large server-based storage system configured for centralized archival and sharing of information. As such, in addition to the imaging device, a DMS will typically require additional hardware and/or software for the management of electronic documents and images. Therefore, a traditional DMS may not be a convenient solution for personal management of electronic documents and images.

A number of patents and publications attempt to provide a convenient solution for personal electronic document management.

For example, U.S. Pat. No. 7,275,063 describes a computer data processing system including a central processing unit configured with a novel integrated computer control software system for the management of data objects including dynamic and automatic organization, linking, finding, cross-referencing, viewing and retrieval of multiple objects regardless of nature or source. However, U.S. Pat. No. 7,275,063 requires the utilization of two databases, i.e., an object-oriented database and a metadata database. Additionally, U.S. Published Patent Application No. 2005-0226473 describes the creation and management of digital originals of signed documents in “document sets.” However, US Published Patent Application No. 2005-0226473 does not describe how a “document set” is created, managed or accessed by a user. Further, each of GB 2334799 and GB 2234800 describe a DMS operated on a personal computer.

Accordingly, it is desirable to provide systems, methods and devices for personal electronic document management.

### SUMMARY OF THE INVENTION

The present disclosure describes, in one embodiment, a system for personal document management. More specifically, the system includes a multifunction peripheral coupled to an interface module. The interface module includes a processor circuit with instructions for manipulating electronic files. Additionally, the system includes a personal document container. According to the present system, the personal document container includes an XPS file. Further, the interface module is capable of managing the personal document container.

The present disclosure also describes methods for managing personal document containers. In an embodiment, a method for managing electronic documents is provided. According to the method, a personal document may be created, accessed or modified at the interface module of a multifunctional peripheral. The interface module includes a processor circuit with instructions for manipulating electronic files. Additionally, the interface module is configured to be capable of creating, accessing, or modifying the personal document container. The personal document container includes an XPS file.

In addition to systems and methods, the present disclosure also describes devices. According to one embodiment, a multifunction peripheral device is provided. The multifunction peripheral device includes an interface module. The interface module includes a processor circuit with instructions for manipulating electronic files. Additionally, the interface module is configured to be capable of creating, accessing or modifying a personal document container. Further, the personal document container includes an XPS file.

### BRIEF DESCRIPTION OF THE DRAWINGS

The features, nature, and advantages of the presently disclosed methods and apparatuses will become more apparent from the detailed description set forth below when taken in conjunction with the drawings in which like reference characters identify corresponding items throughout and wherein:

FIG. 1 shows a diagram of one embodiment of a system according to the present disclosure.

FIG. 2 shows a flow chart representing one embodiment of a method of managing electronic documents according to the present disclosure.

FIG. 3 shows a flow chart representing one embodiment of a method of creating a personal document container according to the present disclosure.

FIG. 4 shows a flow chart representing one embodiment of a method of modifying a personal document container according to the present disclosure.

### DETAILED DESCRIPTION

The present subject will now be described with reference to the drawing figures, in which like reference numerals refer to like parts throughout.

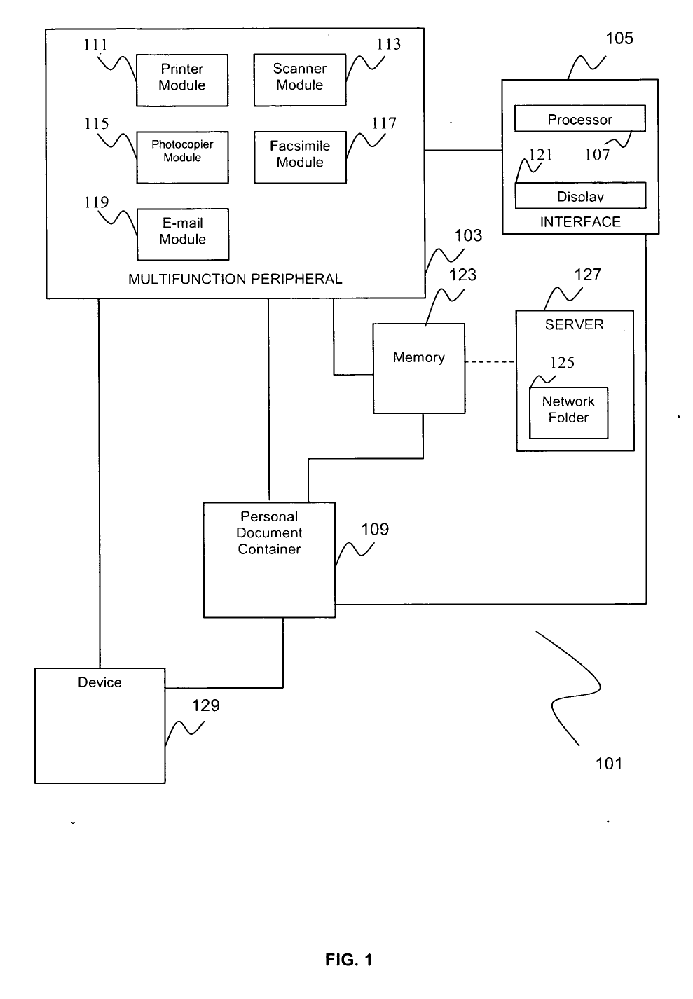

With reference to FIG.1, shown is a diagram of one embodiment of a system according to the present disclosure. The system 101 includes a multifunction peripheral 103 connected to an interface module 105. The interface module 105 includes a processor circuit 107 with instructions for manipulating electronic files. Additionally, a personal document container 109 is also provided. According to one embodiment of the present subject matter the personal document 109 container includes an XPS file. The interface module 105 is configured to be capable of creating, modifying or accessing the personal document container 109.

Generally, the multifunction peripheral 103 includes the functions of two or more traditionally separated imaging devices. According to the embodiment shown, the multifunction peripheral includes a printer module 111 capable of printing documents, a scanner module 113 capable of scanning documents, a photocopier module 115 capable of making photocopies of documents, a facsimile module 117 capable of sending and receiving facsimiles and an e-mail module 119 capable of sending and receiving emails. While the multifunction peripheral 103 may combine any number of imaging devices, generally the multifunction peripheral 103 will have two or more functions with the capability to print, scan, copy, email or send and/or receive facsimiles.

In addition, the multifunction peripheral may contain any number of computing resources for data storage and processing such as processors, hard disk drives, internal memory and other devices.

In addition to a processor circuit 107, the interface module 105 may also include a display 121. The display 121 may be a manual display, an electronic display, or any combination thereof. The display 121 may include any number of buttons, knobs and other user input devices. The display 121 may include an additional display panel, which can be for display only or can be a touch panel display that enables user input directly on the display 121. Also, the entire display 121 may be a touch panel.

A multifunction peripheral 103 configured with touch panel displays or displays with buttons arranged in cooperation with the display may display menu data on a menu. The menu may be selected by user input. Often, menus are navigated through the use of buttons and the display. Optionally, the multifunctional peripheral 103 may provide a number of menus for different parts of the user interface. Menu data may driven by an on-board server module connected to the multifunctional peripheral 103.

The display 121 may be on the front panel of the imaging device. Additionally, the display 121 may be remotely accessible, such as from a web browser or a network computer.

The interface module 105 may be directly coupled to the multifunctional peripheral 103. In the alternative, the interface module 105 may be coupled to the multifunctional peripheral 103 by any acceptable wire. Additionally, the interface module 105 may be in more than one part. For example, the interface module 105 may include two parts configured for wireless communication. In this regard, one part of the interface module 105 may be coupled to the multifunctional peripheral 103 at an input port. The second part of the interface module may be a mobile unit in communication with the first part.

The interface module 105 according to the present subject matter is configured sufficiently for a user to select numerous different functions. According to one embodiment, a user presses a button on the interface module to select an option. Information is sent to and from the multifunctional peripheral 103 and the interface module 105 via the processor circuit 107. However, the interface module 105 may be configured to be capable of performing any alternative mechanisms for selecting a function, including, for example, knobs, switches and the like.

With regard to the personal document container 109, an XPS file may be used. In alternate embodiments, other file types suitable for storing electronic documents and/or images may be utilized.

XML Paper Specification (XPS) is a fixed-layout electronic file format that preserves document formatting and enables file sharing. The XPS format ensures that when the file is viewed online or printed, it retains the format that was intended. XPS provides users and developers with a robust, open and trustworthy format for electronic paper. XPS is a document storage and viewing format that uses Extensible Markup Language (XML) and other industry standards to create a cross-platform document format. XPS describes electronic paper in a way that can be read by hardware, read by software, and read by people. An XPS Document provides a page-by-page view of a document's content as it would be printed.

An XPS file may be a container designed to be capable of containing a variety of electronic documents and images. For example, an XPS file is capable of containing images in formats including JPEG, TIFF, PNG and HD Photo, among others. Additionally, XPS files are capable of containing annotations and metadata. In order to allow for page-by-page modifications, each page in an XPS file is contained as a separate XML stream, i.e., a FixedPage. Pages may also be grouped into documents, i.e., a FixedDocument, each of which is another separate XML stream which references the FixedPage streams making up that document, and any resources and metadata associated with them. In an XPS file, each page, document and file may also have a print ticket for printing associated with it. In an XPS file, pages that form part of different documents may be bundled into a single file for ease and reliability of transmission and sharing, while retaining their logical separation.

In addition to the components disclosed in the foregoing, the system 101 includes a memory module 123 for the storage of data such as an XPS file. In this regard, the personal document container 109 may be stored on the memory module 123.

The memory module 123 may be either fixed to a component in the systems according to the present disclosure, or may be a portable memory module. For example, the memory module 123 may be coupled to the multifunction peripheral 103. In this regard, the memory module 123 may be an integrated part of the multifunction peripheral 103. In an alternative embodiment, the memory module 123 may be a removable memory module such as, for example, a portable USB flash drive, a zip drive, a portable floppy drive, or any type of flash memory, among others. Additionally, the memory module 123 may be a hard drive. The hard drive could be separate from, or connected to, the multifunction peripheral 103. In yet another alternate embodiment, the memory module 123 may be a network folder 127 shared on a server to which the multifunction peripheral 103 is connected.

Any number of personal document containers 109 may be created, modified or accessed utilizing the system 101. In one embodiment of the present subject matter, the personal document container 109 may be created, modified or accessed from the multifunctional-peripheral. However, the personal document container may also be created, modified or accessed on a device 129 connected to the multifunction peripheral 103. In one embodiment, the device may include a computer, personal computer, or the like.

The multifunction peripheral 103 may be configured to perform one or more document management task(s). Non-limiting examples of such tasks include adding a document; deleting a document; printing a document; sending a document; reordering pages within a document; splitting a document into multiple documents; extracting a document, modifying the format of a document; saving a document in an alternative format; image enhancement and optical character recognition.

In addition, the device 129 may also be configured to perform one or more document management task(s). Non-limiting examples of such tasks include adding a document; deleting a document; printing a document; sending a document; reordering pages within a document; splitting a document into multiple documents; extracting a document; modifying the format of a document; saving a document in an alternative format; image enhancement and optical character recognition, and combinations thereof.

Further, the multifunction peripheral 103 may be configured to perform one or more page-level task(s). Non-limiting examples of such tasks include, for example, adding pages; deleting pages; printing pages and sending images of the document, and combinations thereof.

In addition the device 123 may also be configured to perform to perform one or more of page-level task(s). Non-limiting examples of such tasks include, for example, adding pages, deleting pages, printing pages and sending images of the document, and combinations thereof.

Furthermore, any hardware or software may be included in the system to perform the foregoing page-level and document management tasks. In this regard, the device 129 may include software capable of creating, modifying and accessing the personal document container 109.

In one embodiment, no hardware or software outside of the multifunctional peripheral is required to create, modify and/or access the personal document container.

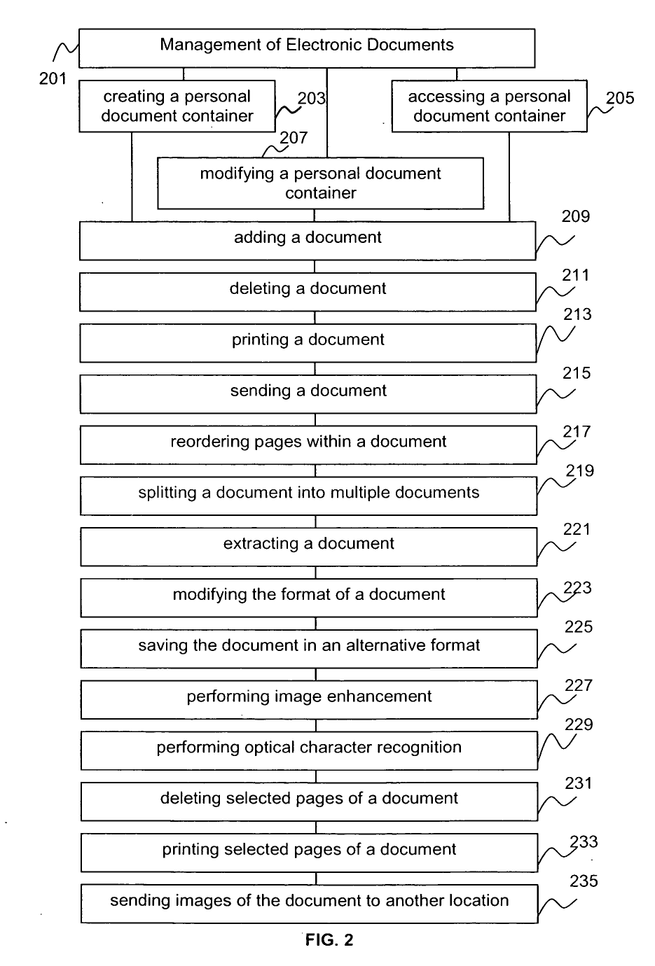

Turning now to FIG. 2, shown is a flow chart representing one embodiment of a method of managing electronic documents according to the present disclosure. The flow chart shown is a non-limiting example. In this regard, any step in the flow chart may be performed in any order. Additionally, steps may be removed or added.

According to the present disclosure, document managing, or related terms, refer to any act or acts, whether passive or active, involving any type of document. Non-limiting examples of document management include one or more of creating, accessing, modifying, storing, organizing, transmitting, retrieving, manipulating, and updating a document, among others. Additionally, any part of the present disclosure and claims which disclose any form or function of document management referred to herein is meant to be fully substitutable with any other form or function of document management also referred to herein.

In the embodiment shown in FIG. 2, management of electronic documents 201 includes three separate actions, i.e., creating a personal document container 203, accessing a personal document container 205 and modifying a personal document container 207. In an embodiment, each of creating, accessing and modifying occurs at an interface module connected to a multifunctional peripheral. Further, the interface module includes a processor circuit with instructions for manipulating electronic files. In addition, the interface module is configured to be capable of creating, accessing, or modifying the personal document container. In one embodiment, the personal document container includes an XPS file.

According to the method shown, any of creating a personal document container 203, accessing a personal document container 205 and modifying a personal document container 207 may include one or more of adding a document 209, deleting a document 211, printing a document 213, sending a document 215, reordering pages within a document 217, splitting a document into multiple documents 219, extracting a document 221, modifying the format of a document 223, saving the document in an alternative format 225, performing image enhancement 227, performing optical character recognition 229, deleting selected pages of a document 231, printing selected pages of a document 233 and sending images of the document to another location 235, among others.

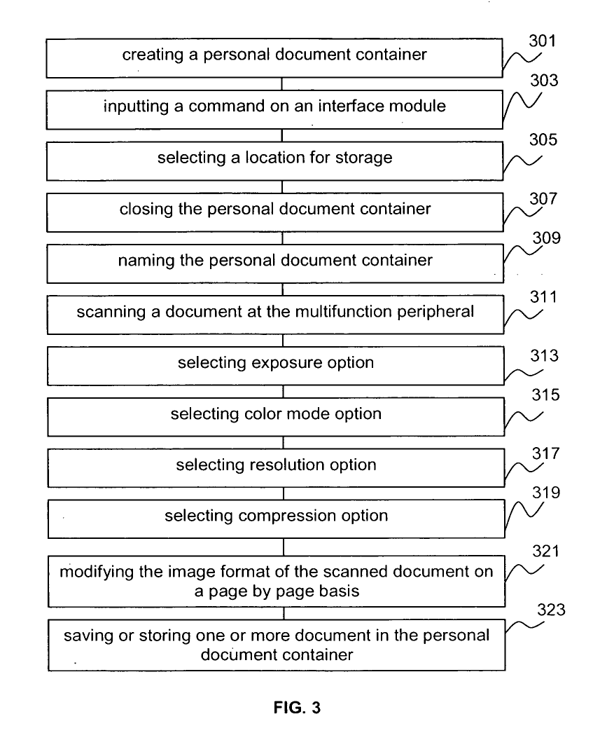

With reference to FIG. 3, shown is a flow chart representing one embodiment of a method of creating a personal document container according to the present disclosure. The flow chart shown is a non-limiting example. In this regard, any step in the flow chart may be performed in any order. Additionally, steps may be removed or added.

According to the method shown in FIG. 3, creating a personal document container 301 includes inputting a command on an interface module of the multifunction peripheral to create the personal document container 303. The interface module includes a processor circuit with instructions for manipulating electronic files. In addition, the interface module is configured to be capable of creating the personal document container. Also, a location for storage of the personal document container is selected 305. Additionally, the personal document container is closed 307. According to the embodiment shown, the personal document container includes an XPS file.

In addition to the aforementioned, the method of creating a personal document container 301 may optionally include naming the personal document container 309, and scanning at least one document at the multifunction peripheral 311 to create one or more electronic documents.

In the embodiment shown, scanning may further include optionally selecting one or more of an exposure option 313, a color mode option 315, a resolution option 317 and a compression option 319, among others.

Also, in the embodiment shown, the interface module provides the capability for optionally modifying the image format of the scanned document on a page by page basis 321. In an alternate embodiment, the interface module may provide the capability to optionally modify the image format of the scanned document on as a whole. In yet another embodiment, no modification at all is performed.

In one embodiment the electronic documents are created, stored or modified into one or more formats. Non-limiting examples of possible electronic formats according to the present disclosure include JPEG, TIFF, PNG and HD Photo.

In one embodiment, the personal document container created by a method according to the present disclosure is capable of containing one or more documents in electronic form. Where one or more documents exist, optionally the documents may be named. In the alternative, no name may be provided for the electronic document. Further, in another embodiment a default name supplied by the systems, methods and devices disclosed herein may also be selected.

The methods according to the present disclosure may also optionally include saving or storing one or more document 323 in the personal document container. As such the personal document container is understood to be capable of containing one or more electronic document in electronic form.

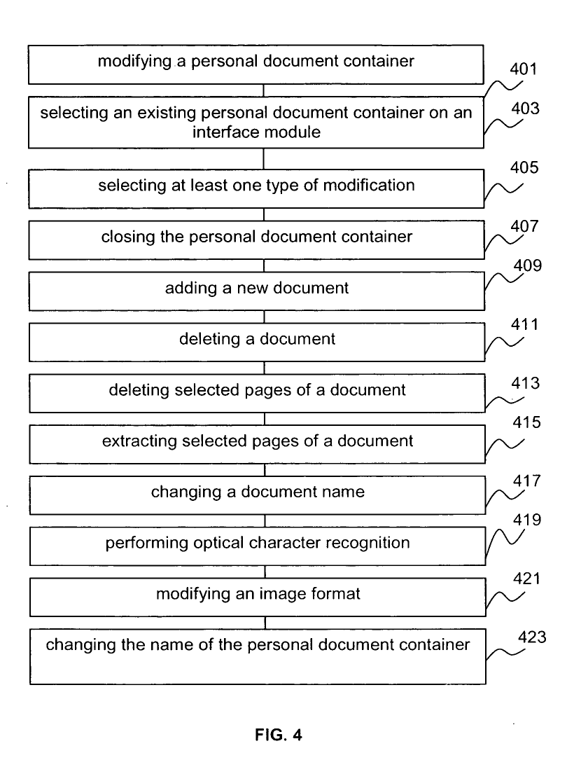

Turning now to FIG. 4, shown is a flow chart representing one embodiment of a method of modifying a personal document container according to the present disclosure. The flow chart shown is a non-limiting example. In this regard, any step in the flow chart may be performed in any order. Additionally, steps may be removed or added.

According to the embodiment shown in FIG. 4, modifying the personal document container 401 includes selecting an existing personal document container on an interface module connected to a multifunctional peripheral 403. The interface module includes a processor circuit with instructions for manipulating electronic files, or the like and is configured to be capable of modifying a personal document container. According to the method, at least one type of modification on the interface module is selected 405. The personal document container is then closed 407. According to the shown embodiment, the personal document container includes an XPS file.

In addition to the foregoing steps, the method of modifying a personal document container 401 may optionally include one or more steps including, for example, adding a new document to the personal document container 409, adding pages to an existing document 411, deleting a document 413, deleting selected pages of a document 415, extracting selected pages of a document 417, changing a document name 419, modifying an image format of at least one part of a document 421 and changing the name of the personal document container 423.

Also provided for by the present disclosure is a multifunction peripheral device. The multifunction peripheral device is provided as discussed in conjunction with the system disclosed above.

The present disclosure also describes a personal document container. In one embodiment the personal document container includes an XPS file capable of containing one or more electronic documents in electronic form. Additionally, the personal document container is created, modified or accessed on a multifunction peripheral comprising an interface module connected thereto. The interface module includes a processor circuit with instructions for manipulating electronic files including the personal document container.

The previous description of some aspects is provided to enable any person skilled in the art to make or use the present invention. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Thus, the present invention is not intended to be limited to the aspects shown herein but is to be accorded the widest scope consistent with the principles and novel features disclosed herein.

What is claimed is:

1. A system, comprising:
a multifunction peripheral;
an interface module connected to the multifunctional peripheral, the interface module including a processor circuit with instructions for manipulating electronic files;
a personal document container comprising an XPS file,
wherein the interface module is configured to be capable of creating, modifying or accessing the personal document container.

2. The system of claim 1, wherein the multifunction peripheral comprises at least one module selected from the group consisting of a printer module, a scanner module, a photocopier module, a facsimile module, an e-mail module and a memory module.

3. The system of claim 2, wherein the personal document container is stored on the memory module.

4. The system of claim 2, wherein the memory module is coupled to the multifunction peripheral.

5. The system of claim 5, wherein the memory module is selected from the group consisting of a removable memory module, a hard drive and a network folder shared on a server to which the multifunction peripheral is connected.

6. The system of claim 1, wherein the personal document container is created, modified or accessed from the multifunctional peripheral.

7. The system of claim 2, wherein the personal document container is created, modified or accessed from a device connected to the multifunction peripheral.

8. The system of claim 1, wherein the multifunction peripheral is configured to perform a document management task comprising one or more of adding a document; deleting a document; printing a document; sending a document; reordering pages within a document; splitting a document into multiple documents; extracting a document; modifying the format of a document; saving a document in an alternative format; image enhancement and optical character recognition.

9. The system of claim 7, wherein the device is configured to perform a page level task comprising one or more of adding pages, deleting pages, printing pages and sending images of the document.

10. The system of claim 1, wherein no hardware or software outside of the multifunctional peripheral is required to create, modify and/or access the personal document container.

11. A method for managing electronic documents using a multifunctional peripheral, comprising:
creating, accessing or modifying a personal document container at an interface module connected to a multifunctional peripheral, the interface module including a processor circuit with instructions for manipulating electronic files;
wherein the personal document container includes an XPS file, and
wherein the interface module is configured to be capable of creating, accessing, or modifying the personal document container.

12. The method of claim 11, wherein creating the personal document container further comprises:
inputting a command on an interface module of the multifunction peripheral to create the personal document container, the interface module including a processor circuit with instructions for manipulating electronic files;
selecting a location for storage of the personal document container; and
closing the personal document container,
wherein the personal document container includes an XPS file, and
wherein the interface module is configured to be capable of creating the personal document container.

13. The method of claim 11, further comprising one or more of naming the personal document container, scanning at least one document at the multifunction peripheral to one or more electronic in one or more electronic format selected from the group consisting of JPEG, TIFF, PNG and HD Photo, modifying the image format on a page by page basis, comprising naming the at least one document, saving the at least one document in the personal document container.

14. The method of claim 1, wherein modifying the personal document container further comprises:
selecting an existing personal document container on an interface module in communication with the multifunctional peripheral, the interface module including a processor circuit with instructions for manipulating electronic files;
selecting at least one type of modification on the interface module; and
closing the personal document container following completion of the modification,
wherein the personal document container includes an XPS file, and
wherein the interface module is configured to be capable of modifying the personal document container.

15. The method of claim 14, wherein the modification comprises one or more of adding a new document, adding pages to an existing document, deleting a document, deleting selected pages of a document, extracting selected pages of a document, changing a document name, modifying an image format of at least one part of a document and changing the name of the personal document container.

16. The method of claim 11, wherein the command to create, access or modify comprises one or more of adding a document, deleting a document, printing a document, sending a document, reordering pages within a document, splitting a document into multiple documents, extracting a document, modifying the format of a document, saving the document in an alternative format, performing image enhancement, performing optical character recognition, deleting selected pages of a document, printing selected pages of a document and sending images of the document to another location.

17. A multifunction peripheral device, comprising:
an interface module connected to the multifunctional peripheral device including a processor circuit with instructions for manipulating electronic files, the interface module being configured to be capable of creating, accessing or modifying a personal document container;
wherein the personal document container comprises an XPS file.

18. The multifunction peripheral device of claim 1, further comprising one of more of a printer module, a scanner module, photocopier module, a facsimile module, an e-mail module and a memory module.

19. The multifunction peripheral device of 1, wherein the personal document is created, modified or accessed on the interface and is capable of containing one or more electronic documents in electronic form.

20. The multifunction peripheral device of claim 1, wherein no hardware or software outside of the multifunctional peripheral is required to create, modify and/or access the personal document container.
